(19) United States
(12) Patent Application Publication
(10) Pub. No.: US 2026/0050136 A1
(43) Pub. Date: Feb. 19, 2026

(54) DEVICE

(71) Applicant: TDK TAIWAN CORP., Taoyuan City (TW)

(72) Inventors: Ying-Jen WANG, Taoyuan City (TW); Ya-Hsiu WU, Taoyuan City (TW); Yi-Ho CHEN, Taoyuan City (TW)

(21) Appl. No.: 19/295,001

(22) Filed: Aug. 8, 2025

Related U.S. Application Data
(60) Provisional application No. 63/683,803, filed on Aug. 16, 2024.

(51) Int. Cl. G02B 7/02

(52) U.S. Cl. CPC G02B 7/02

(57) ABSTRACT

An optical element driving mechanism is provided. The optical element driving mechanism includes a movable portion, a fixed portion, and a driving assembly. The movable portion is configured to connect an optical element. The movable portion is movable relative to the fixed portion. The driving assembly is configured to drive the movement of the movable portion.

### CROSS REFERENCE TO RELATED APPLICATIONS

This application claims the benefit of U.S. provisional application No. 63/683,803, filed Aug. 16, 2024, the entirety of which is incorporated by reference herein.

### TECHNICAL FIELD

The present disclosure relates to an optical element driving mechanism, and, in particular, it relates to an optical element driving mechanism that includes circuit elements and reinforcement elements.

### BACKGROUND

With the advancement of technology, many modern electronic devices—such as notebook computers, smartphones, and digital cameras—have been equipped with photography and video recording functions. These electronic devices have become increasingly prevalent, and while aiming to achieve a more stable and higher-quality optical performance, their designs are also trending toward greater convenience and slimness, offering users more options.

In view of the above, there is a need for an optical element driving mechanism that allows adjustment of the optical imaging to accommodate various external imaging requirements. At the same time, it is desirable to reduce operational errors caused by interference with magnetic components during operation, stabilize the internal structure, and provide more stable and higher-quality optical performance.

### BRIEF SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a movable portion, a fixed portion, and a driving assembly. The movable portion is configured to connect to an optical element. The movable portion is movable relative to the fixed portion. The driving assembly is configured to drive the movement of the movable portion.

According to certain aspects of the present disclosure, the optical element driving mechanism further includes a circuit assembly configured to connect to an external circuit. The circuit assembly includes a first circuit element and a second circuit element. The first circuit element includes a fixed end, a movable end, a plate-shaped main body, and a flexible portion. The fixed end is at least partially fixedly connected to the fixed portion. The movable end is at least partially fixedly connected to the movable portion. The movable end is movably connected to the fixed end via the flexible portion and the plate-shaped main body.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1A is a perspective view of an optical element driving mechanism and an optical element, according to certain aspects of the present disclosure.

FIG. 1B is a perspective view of the optical element driving mechanism and the optical element, according to certain aspects of the present disclosure, with the housing removed for illustrative purposes.

FIG. 2 is an exploded perspective view of the optical element driving mechanism and the optical element, according to certain aspects of the present disclosure.

FIG. 3A is a upper-half part exploded perspective view of the optical element driving mechanism and the optical element, according to certain aspects of the present disclosure.

FIG. 3B is a lower-half part exploded perspective view of the optical element driving mechanism and the optical element, according to certain aspects of the present disclosure.

FIG. 4 is a bottom perspective view of a first movable element of the optical element driving mechanism, according to certain aspects of the present disclosure.

FIG. 5A is a perspective view of a second movable element and a fourth movable element of the optical element driving mechanism, according to certain aspects of the present disclosure.

FIG. 5B is a bottom perspective view of the second movable element and the fourth movable element of the optical element driving mechanism, according to certain aspects of the present disclosure.

FIG. 6 is a perspective view of a third movable element of the optical element driving mechanism, according to certain aspects of the present disclosure.

FIG. 7 is a perspective view of a first circuit element of the optical element driving mechanism, according to certain aspects of the present disclosure.

FIG. 8 is a perspective view of the optical element driving mechanism, according to certain aspects of the present disclosure, with the housing removed for illustrative purposes.

FIG. 9 is a perspective view of a reinforcement assembly of the optical element driving mechanism, according to certain aspects of the present disclosure.

FIG. 10 is a perspective view of the reinforcement assembly and the driving assembly of the optical element driving mechanism, according to certain aspects of the present disclosure.

FIG. 11 is a perspective view of the optical element driving mechanism, according to certain aspects of the present disclosure, with the fixed portion removed and the first movable element shown in dashed lines for illustrative purposes.

FIG. 12 is a perspective view of the optical element driving mechanism according to certain aspects of the present disclosure, with the fixed portion and the first movable element removed, and with the second movable element and the fourth movable element shown in dashed lines for illustrative purposes.

### DETAILED DESCRIPTION

Various embodiments are described with reference to the drawings, in which like reference numerals are used throughout to designate similar or equivalent elements. The drawings are not drawn to scale and are provided solely for the purpose of illustrating the features and characteristics of the present disclosure. It should be understood that numerous specific details, relationships, and methods are set forth to provide a thorough understanding. However, it will be readily apparent to those of ordinary skill in the art that various embodiments may be practiced without one or more of the specific details, or with alternative methods. In some instances, well-known structures or operations are not shown in detail for illustrative clarity. The various embodiments are not limited to the illustrated order of operations or events, as some operations may occur in different sequences and/or concurrently with other operations or events. Moreover, not all illustrated operations or events are required for implementing certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The present disclosure relates to an optical element driving mechanism that includes a driving assembly, movable elements, and a guiding portion, which enable flexible movement of the movable portion and the optical element in various directions, thereby adjusting the imaging of the optical element driving mechanism to accommodate different imaging requirements.

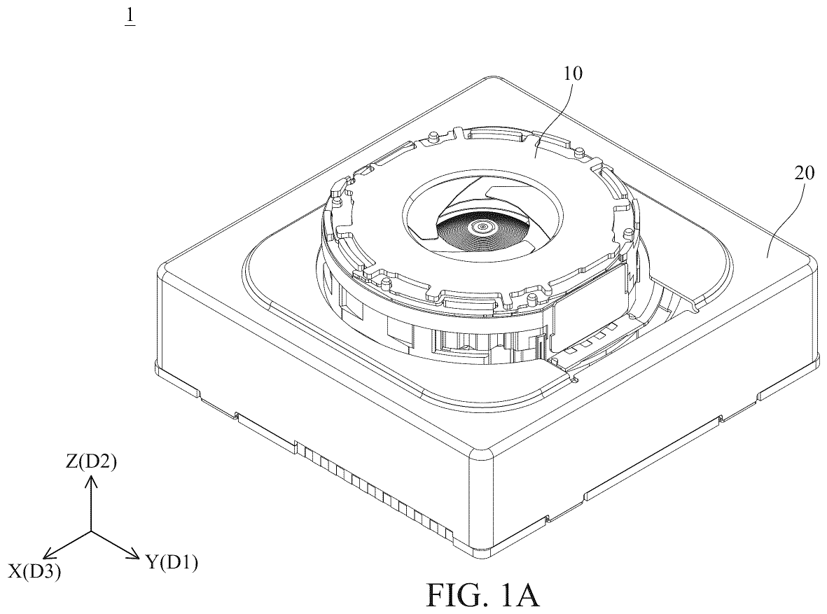

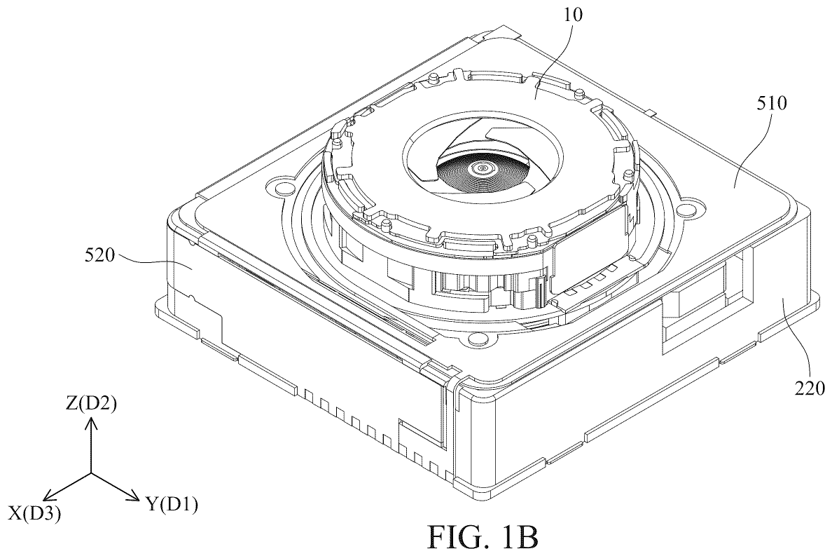

First, please refer to FIGS. 1A and 1B together. FIG. 1A is a perspective view of an optical element driving mechanism 1 and an optical element 10, according to certain aspects of the present disclosure. FIG. 1B is a perspective view of the optical element driving mechanism 1 and the optical element 10, according to certain aspects of the present disclosure, with a housing 210 removed for illustrative purposes.

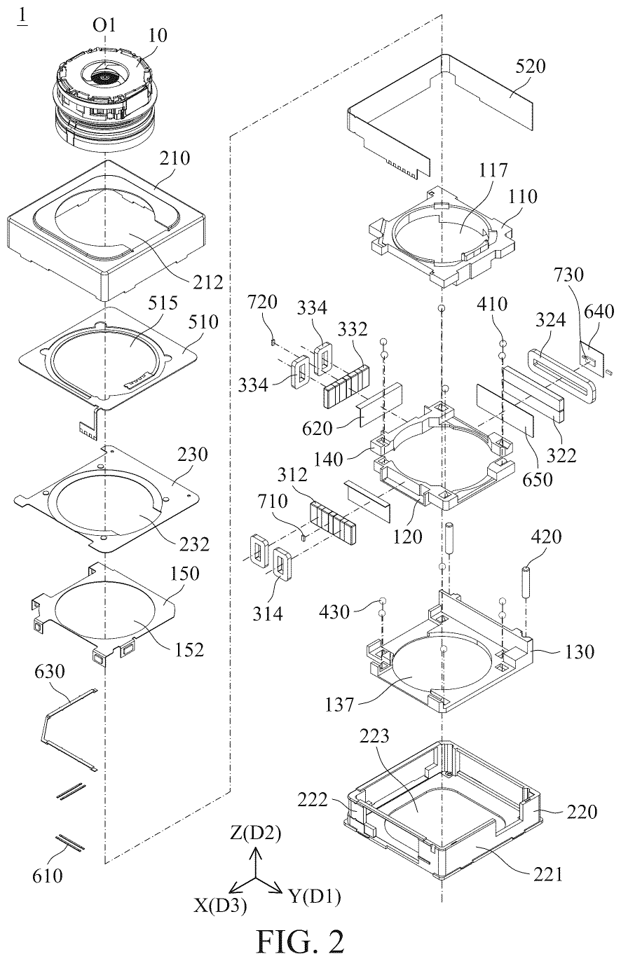

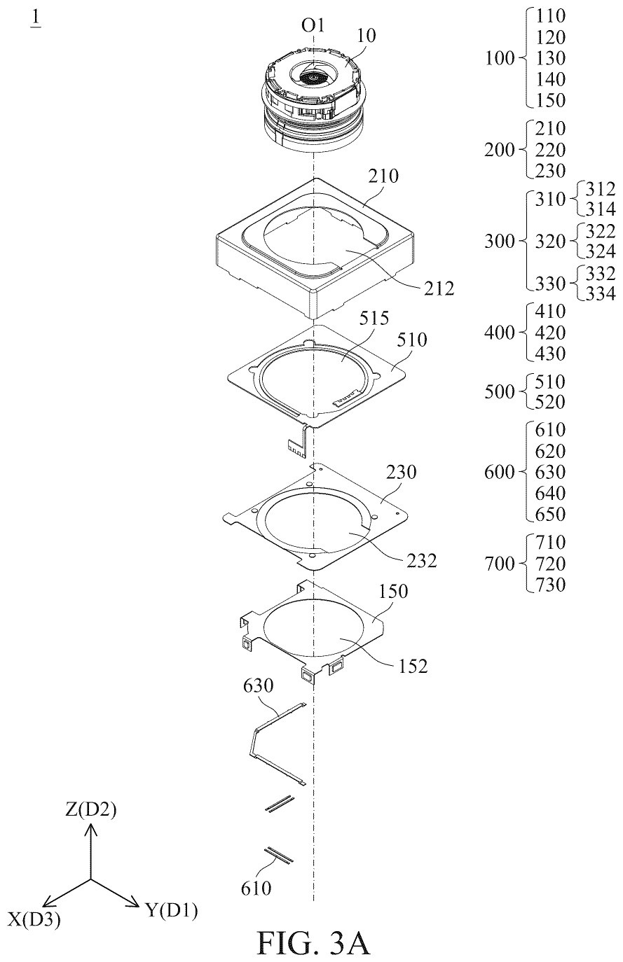

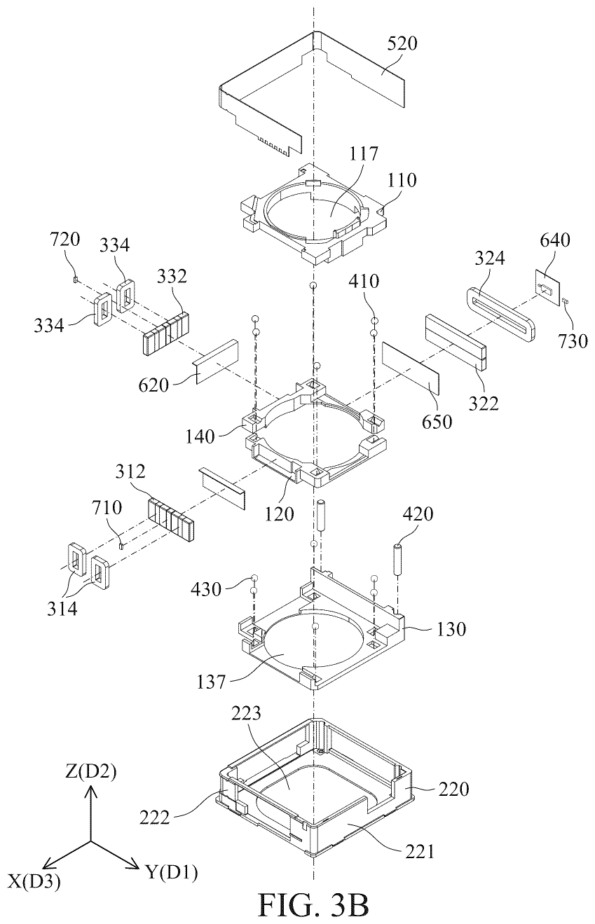

Next, please refer to FIGS. 2 through 3B together. FIG. 2 is an exploded perspective view of the optical element driving mechanism 1 and the optical element 10, according to certain aspects of the present disclosure. FIG. 3A is an exploded perspective view of the upper-half part of the optical element driving mechanism 1 and the optical element 10, according to certain aspects of the present disclosure. FIG. 3B is an exploded perspective view of the lower-half part of the optical element driving mechanism 1 and the optical element 10, according to certain aspects of the present disclosure.

The optical element driving mechanism 1 includes a movable portion 100, a fixed portion 200, a driving assembly 300, a guiding assembly 400, a circuit assembly 500, a reinforcement assembly 600, and a sensing assembly 700. The movable portion 100 is connected to an optical element 10, which may be, for example, an optical lens. The movable portion 100 is movable relative to the fixed portion 200. The driving assembly 300 drives the movement of the movable portion 100. The guiding assembly 400 guides the movement of the movable portion 100 relative to the fixed portion 200. The circuit assembly 500 electrically connects the optical element 10 with the optical element driving mechanism 1. The reinforcement assembly 600 reinforces the internal structure of the optical element driving mechanism 1. The sensing assembly 700 is configured to detect the movement of the optical element 10.

Incident light from the outside passes through the optical element 10 and the optical element driving mechanism 1. The incident light has an optical axis O1. In other words, the optical axis O1 passes through both the optical element 10 and the optical element driving mechanism 1.

The movable portion 100 includes a first movable element 110, a second movable element 120, a third movable element 130, a fourth movable element 140, and a fifth movable element 150. The first movable element 110 is movably connected to the second movable element 120 and the fourth movable element 140 via the guiding assembly 400. The first movable element 110 is movable relative to the second movable element 120, the third movable element 130, the fourth movable element 140, and the fixed portion 200. The fifth movable element 150 is fixedly connected to the first movable element 110, meaning that the fifth movable element 150 moves along with the first movable element 110.

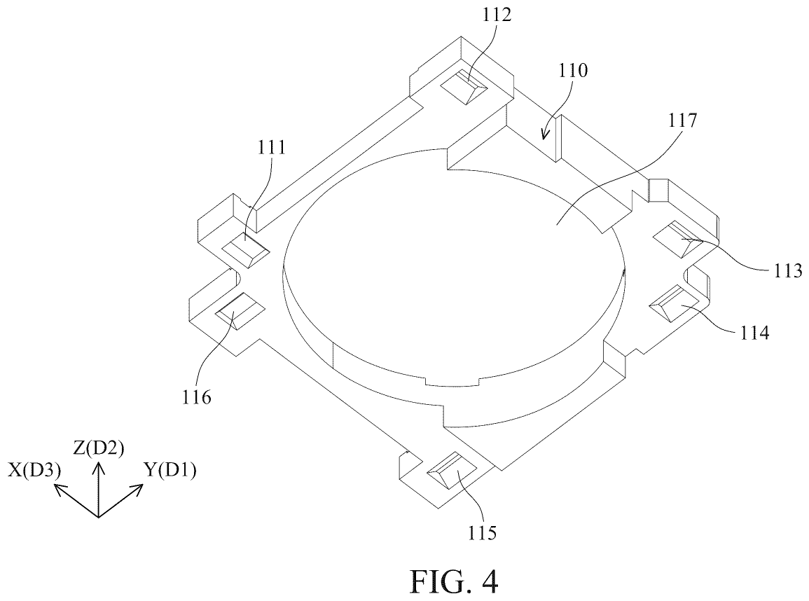

Next, please refer to FIG. 4 together. FIG. 4 is a bottom perspective view of the first movable element 110 of the optical element driving mechanism 1, according to certain aspects of the present disclosure.

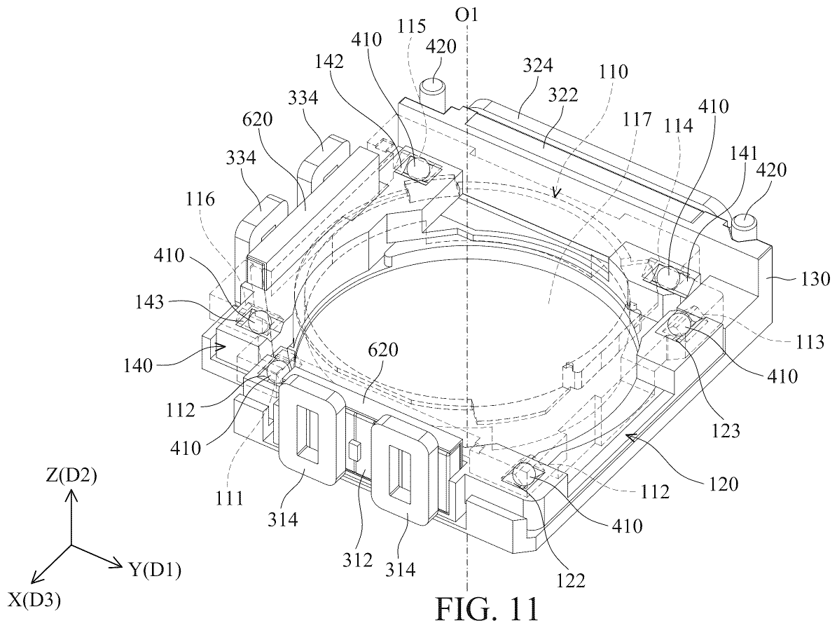

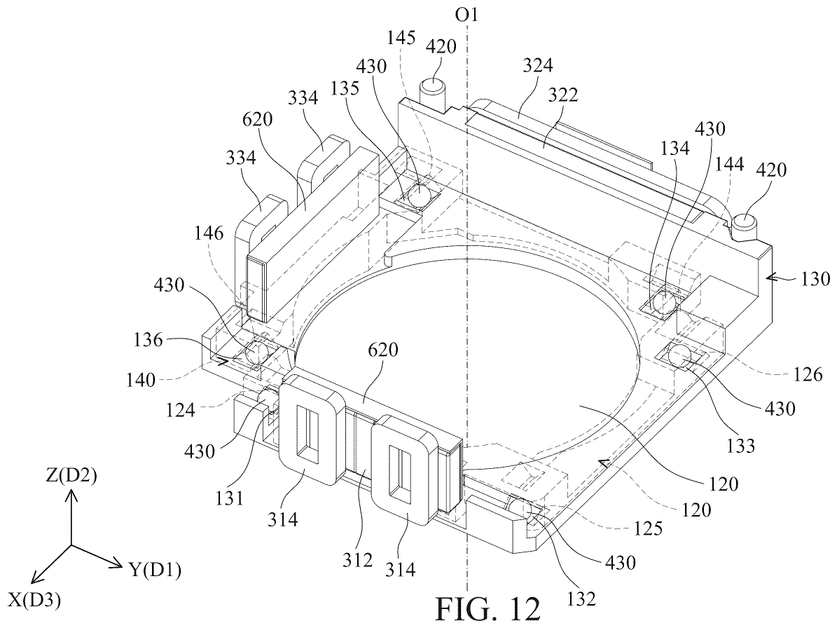

The first movable element 110 is connected to the optical element 10, which may be, for example, an optical lens. The first movable element 110 is movable relative to the fixed portion 200. The first movable element 110 includes first guiding grooves 111, 112, 113, 114, 115, 116, and a first movable element opening 117. The first movable element opening 117 corresponds to the optical element 10. The first guiding grooves 111, 112, and 113 have elongated structures extending along a third dimension D3, while the first guiding grooves 114, 115, and 116 have elongated structures extending along a first dimension D1. The first movable element 110 is movably connected to the second movable element 120 and the fourth movable element 140 via the guiding assembly 400. The driving assembly 300 drives the movement of the first movable element 110 by actuating the second movable element 120 and the fourth movable element 140 (as will be described in detail below with reference to FIGS. 11 and 12).

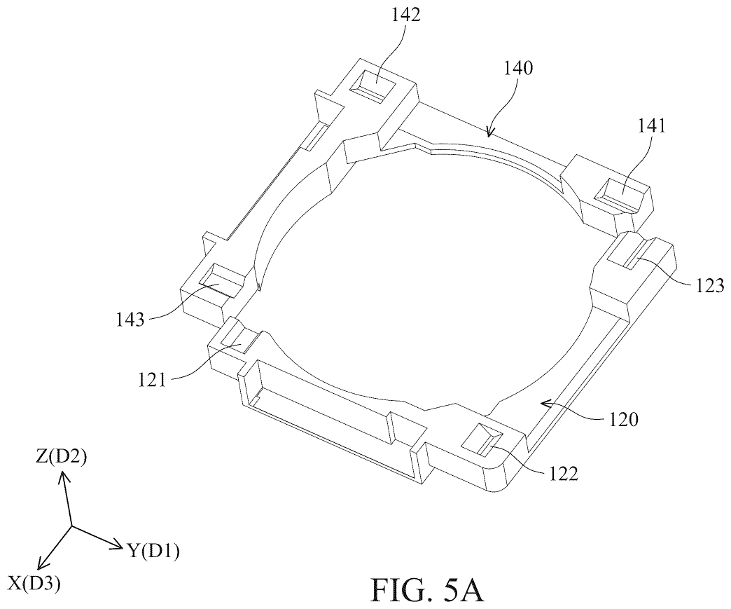

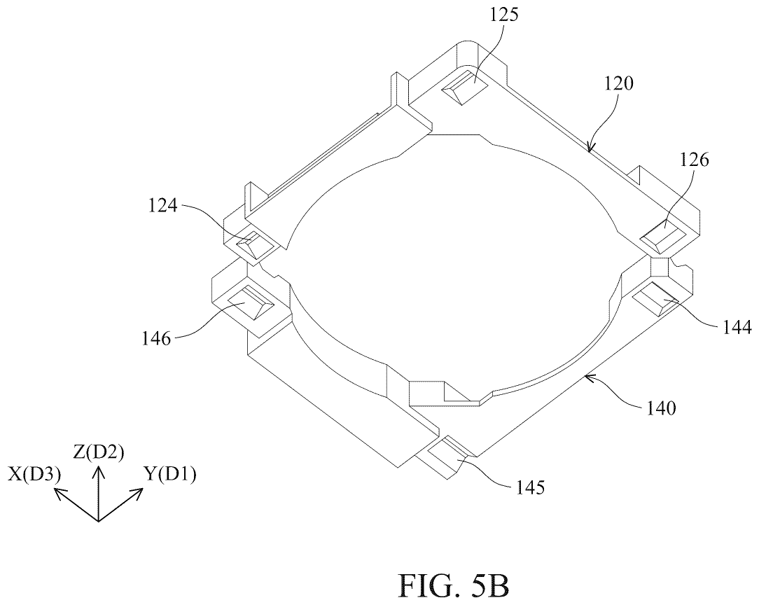

Next, please refer to FIGS. 5A through 5B together. FIG. 5A is a perspective view of the second movable element 120 and the fourth movable element 140 of the optical element driving mechanism 1, according to certain aspects of the present disclosure.

FIG. 5B is a bottom perspective view of the second movable element 120 and the fourth movable element 140 of the optical element driving mechanism 1, according to certain aspects of the present disclosure.

The second movable element 120 is movably connected to the third movable element 130 and the first movable element 110 via the guiding assembly 400. The second movable element 120 includes second guiding grooves 121, 122, 123, 124, 125, and 126. The second guiding grooves 121, 122, and 123 have elongated structures extending along the third dimension D3, while the second guiding grooves 124, 125, and 126 have elongated structures extending along the first dimension D1. The second movable element 120 is movable along the first dimension D1 relative to the fixed portion 200, the third movable element 130, and the fourth movable element 140. The movement of the second movable element 120 drives the movement of the first movable element 110 (as will be described in detail below with reference to FIGS. 11 and 12).

The fourth movable element 140 is movably connected to the third movable element 130 and the first movable element 110 via the guiding assembly 400. The fourth movable element 140 includes fourth guiding grooves 141, 142, 143, 144, 145, and 146. The fourth guiding grooves 141, 142, and 143 have elongated structures extending along the first dimension D1, while the fourth guiding grooves 144, 145, and 146 have elongated structures extending along the third dimension D3. The fourth movable element 140 is movable along the third dimension D3 relative to the first movable element 110, the second movable element 120, the third movable element 130, and the fixed portion 200. The movement of the fourth movable element 140 can drive the movement of the first movable element 110 (as will be described in detail below with reference to FIGS. 11 and 12). When the fourth movable element 140 moves, it does not drive the movement of the second movable element 120.

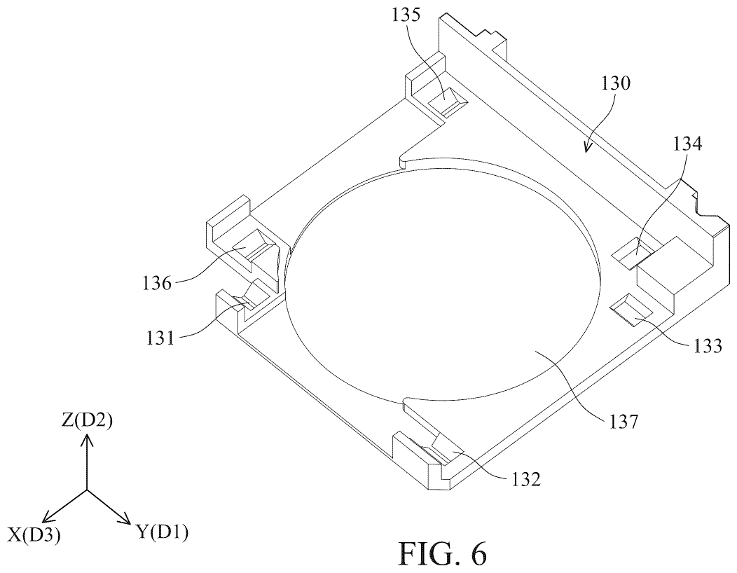

Next, please refer to FIG. 6 together. FIG. 6 is a perspective view of the third movable element 130 of the optical element driving mechanism 1, according to certain aspects of the present disclosure.

The third movable element 130 is movably connected to the fixed portion 200 via the guiding assembly 400. The third movable element 130 is movable relative to the second movable element 120 and the fixed portion 200. The third movable element 130 includes third guiding grooves 131, 132, 133, 134, 135, 136, and a third movable element opening 137. The third movable element opening 137 corresponds to the optical element 10. The third guiding grooves 131, 132, and 133 have elongated structures extending along the first dimension D1, while the third guiding grooves 134, 135, and 136 have elongated structures extending along the third dimension D3. The third movable element 130 is movably connected to the second movable element 120 and the fourth movable element 140 via the guiding assembly 400. The third movable element 130 is movable along a second dimension D2 relative to the fixed portion 200. The movement of the third movable element 130 may drive the movement of the first movable element 110, the second movable element 120, and the fourth movable element 140. When the third movable element 130 moves, the second movable element 120 does not drive the movement of the fourth movable element 140.

Next, please also refer back to FIGS. 3A and 3B together. The fixed portion 200 includes a housing 210, a bottom 220, and a frame 230. The housing 210 includes a housing opening 212. The housing 210 is fixedly connected to the bottom 220. The bottom 220 has an adjacent first side 221, a second side 222, and a bottom opening 223. The bottom 220 and the housing 210 form a first receiving space for accommodating the first movable element 110 and the circuit assembly 500. The frame 230 includes an opening 232. The frame 230 and the housing 210 form a second receiving space for accommodating a first circuit element 510 of the circuit assembly 500.

The first movable element 110 and the first circuit element 510 are located on opposite sides of the frame 230. That is, the first movable element 110 is positioned on the side of the frame 230 facing the bottom 220, while the first circuit element 510 is positioned on the side of the frame 230 opposite the bottom 220. When viewed along the optical axis O1, the first movable element 110 and the first circuit element 510 at least partially overlap.

The driving assembly 300 includes a first driving unit 310, a second driving unit 320, and a third driving unit 330. The first driving unit 310 may be, for example, a driving unit such as a magnet and coil, a piezoelectric element, a stepper motor, or a shape memory alloy. In the present embodiment, the first driving unit 310 includes two first magnetic elements 312 and two first coils 314. The first magnetic elements 312 are at least partially fixedly disposed on the second movable element 120. The first coils 314 correspond to the first magnetic elements 312. The first coils 314 are fixedly disposed on a second circuit element 520 of the circuit assembly 500 and are connected to the second circuit element 520.

By means of the electromagnetic driving force generated between the first magnetic element 312 and the first coil 314, the first magnetic element 312 moves relative to the first coil 314. Accordingly, the second movable element 120 moves relative to the second circuit element 520, and the second movable element 120 drives the movement of the first movable element 110 and the optical element 10. Therefore, the electromagnetic driving force generated between the first magnetic element 312 and the first coil 314 is capable of driving the second movable element 120 to move the first movable element 110 and the optical element 10 relative to the fixed portion 200.

The second driving unit 320 may be, for example, a driving unit such as a magnet and coil, a piezoelectric element, a stepper motor, or a shape memory alloy. In the present embodiment, the second driving unit 320 includes a second magnetic element 322 and a second coil 324. The second magnetic element 322 is at least partially fixedly disposed on the third movable element 130. The second coil 324 corresponds to the second magnetic element 322. The second coil 324 is fixedly disposed on the second circuit element 520 of the circuit assembly 500, to be connected to the second circuit element 520.

By means of the electromagnetic driving force generated between the second magnetic element 322 and the second coil 324, the second magnetic element 322 moves relative to the second coil 324. Accordingly, the third movable element 130 moves relative to the second circuit element 520, and the third movable element 130 drives the movement of the first movable element 110, the second movable element 120, and the optical element 10. Therefore, the electromagnetic driving force generated between the second magnetic element 322 and the second coil 324 is capable of driving the third movable element 130 to move the first movable element 110, the second movable element 120, and the optical element 10 relative to the fixed portion 200, such that the third movable element 130 and the second movable element 120 are movable relative to the second coil 324.

The third driving unit 330 may be, for example, a driving unit such as a magnet and coil, a piezoelectric element, a stepper motor, or a shape memory alloy. In the present embodiment, the third driving unit 330 includes two third magnetic elements 332 and two third coils 334. The third magnetic elements 332 are at least partially fixedly disposed on the fourth movable element 140. The third coils 334 correspond to the third magnetic elements 332. The third coils 334 are fixedly disposed on the second circuit element 520 of the circuit assembly 500, to be connected to the second circuit element 520.

By means of the electromagnetic driving force generated between the third magnetic element 332 and the third coil 334, the third magnetic element 332 moves relative to the third coil 334. Accordingly, the fourth movable element 140 moves relative to the second circuit element 520, and the fourth movable element 140 drives the movement of the first movable element 110 and the optical element 10. Therefore, the electromagnetic driving force generated between the third magnetic element 332 and the third coil 334 is capable of driving the fourth movable element 140 to move the first movable element 110 and the optical element 10 relative to the fixed portion 200, such that the fourth movable element 140 and the first movable element 110 are movable relative to the third coil 334.

The multiple sets of driving mechanisms of the driving assembly 300—including the first coil 314, the second coil 324, the third coil 334, and the first magnetic element 312, the second magnetic element 322, and the third magnetic element 332—enable adjustment of the optical imaging focal length of the optical element 10, thereby accommodating different external imaging requirements and providing sufficient driving force to actuate the first movable element 110, the second movable element 120, the third movable element 130, the fourth movable element 140, and the optical element 10.

The guiding assembly 400 connects the first movable element 110, the second movable element 120, the third movable element 130, and the fourth movable element 140. The guiding assembly 400 includes a first guiding portion 410, a second guiding portion 420, and a third guiding portion 430. The first guiding portion 410 corresponds to the connection between the first movable element 110 and the second movable element 120 and the fourth movable element 140. The second guiding portion 420 corresponds to the connection between the first movable element 110 and the second movable element 120 and the fourth movable element 140 with the third movable element 130. The third guiding portion 430 corresponds to the connection between the third movable element 130, the fourth movable element 140, and the second movable element 120.

In the present embodiment, the first guiding portion 410 includes six rolling balls (only one is labeled in FIG. 3B), each connecting the first guiding grooves 111, 112, 113, 114, 115, and 116 with their corresponding second guiding grooves 121, 122, 123 and fourth guiding grooves 141, 142, 143 (to be further described below with reference to FIGS. 11 and 12). The second guiding portion 420 includes two guide rods (only one is labeled in FIG. 3B), each connecting the first movable element 110 with its corresponding second movable element 120 and third movable element 130, as well as the first movable element 110 with its corresponding fourth movable element 140 and third movable element 130. The third guiding portion 430 includes six rolling balls (only one is labeled in FIG. 3B), each connecting the third guiding grooves 131, 132, 133, 134, 135, and 136 with their corresponding second guiding grooves 124, 125, 126 and fourth guiding grooves 144, 145, 146 (to be further described below with reference to FIGS. 11 and 12).

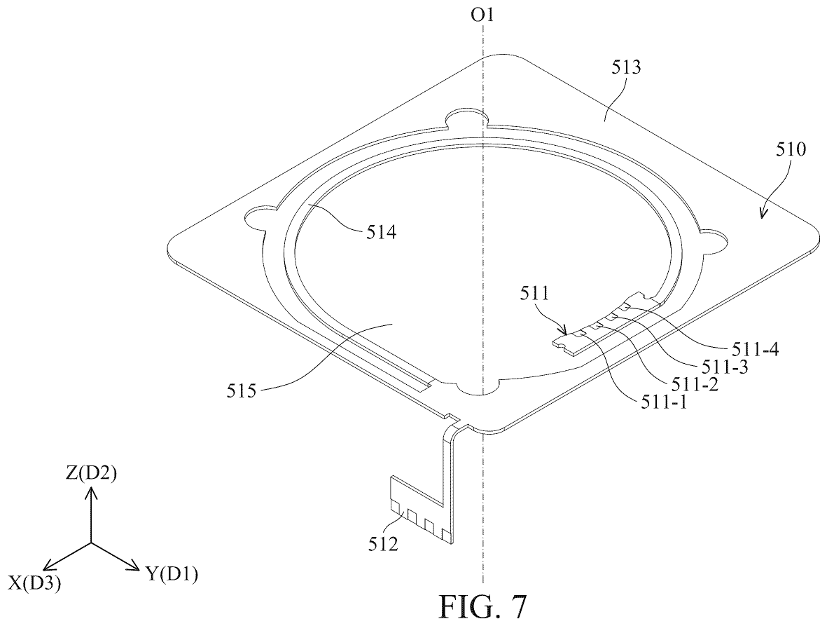

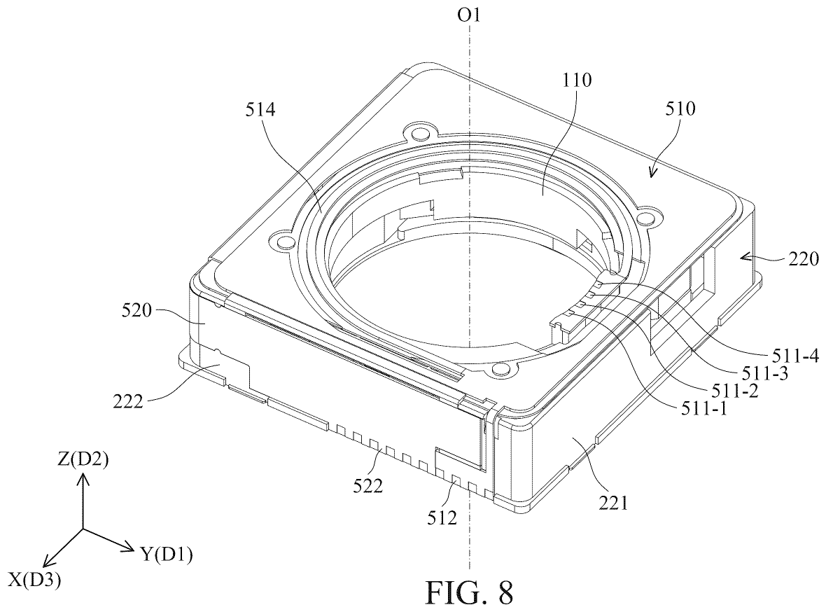

Next, please also refer to FIGS. 7 and 8 together. FIG. 7 is a perspective view of the first circuit element 510 of the optical element driving mechanism 1, according to certain aspects of the present disclosure. FIG. 8 is a perspective view of the optical element driving mechanism 1, according to certain aspects of the present disclosure, with the housing 210 removed for illustrative purposes.

The circuit assembly 500 is for connecting to an external circuit (not shown; for example, an output circuit used for the optical element driving mechanism 1). The circuit assembly 500 includes a first circuit element 510 and a second circuit element 520.

The first circuit element 510 is disposed on the frame 230 of the fixed portion 200. The first circuit element 510 includes a movable end 511, a fixed end 512, a plate-shaped main body 513, a flexible portion 514, and a first circuit element opening 515. The fixed end 512 is at least partially fixedly connected to the bottom 220 of the fixed portion 200. The movable end 511 is at least partially fixedly connected to the first movable element 110. The movable end 511 is movably connected to the fixed end 512 via the flexible portion 514 and the plate-shaped main body 513. When the first movable element 110 is located at an extreme position, for example, when it moves to the lowest position in the second dimension D2 within its movable range, the flexible portion 514 still does not completely contact the frame 230.

The movable end 511 includes a first connection portion 511-1, a second connection portion 511-2, a third connection portion 511-3, and a fourth connection portion 511-4. The second connection portion 511-2 is located between the first connection portion 511-1 and the third connection portion 511-3. The first connection portion 511-1, second connection portion 511-2, third connection portion 511-3, and fourth connection portion 511-4 are for electrically connecting an optical element module (for example, a variable aperture, lens actuator, image sensor actuator, vibration motor, fingerprint sensor, or any other electronic module). The first connection portion 511-1, the second connection portion 511-2, the third connection portion 511-3, and the fourth connection portion 511-4 are electrically connected to the fixed end 512 via the flexible portion 514.

When viewed along the optical axis O1, the first connection portion 511-1, the second connection portion 511-2, the third connection portion 511-3, and the fourth connection portion 511-4 are arranged along a straight line parallel to the first side 221. The flexible portion 514 extends around the optical axis O1 by at least 180 degrees. Preferably, the flexible portion 514 extends around the optical axis O1 by more than 270 degrees.

The second circuit element 520 is disposed on the bottom 220 of the fixed portion 200. The second circuit element 520 includes an external connection terminal 522 configured to output electrical signals from the optical element driving mechanism 1. The external connection terminal 522 is at least partially fixedly connected to the fixed portion 200. The external connection terminal 522 and the fixed end 512 of the first circuit element 510 are located between the second side 222 and the housing 210. The external connection terminal 522 and the fixed end 512 respectively include a plurality of connection portions, which are arranged parallel to the second side 222.

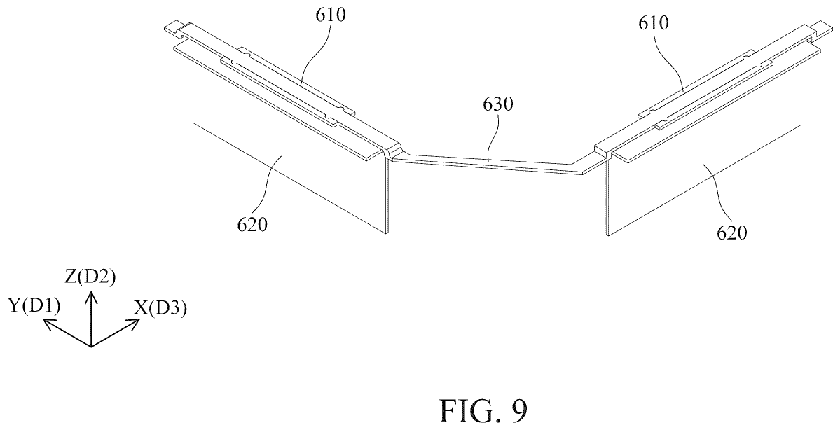

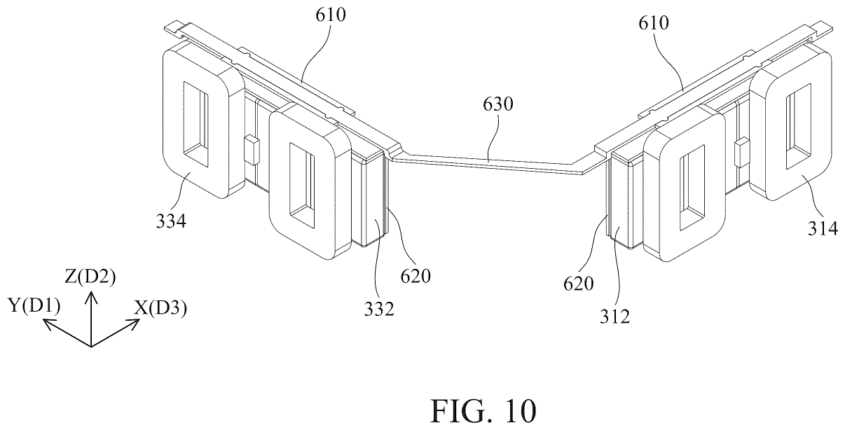

Next, please also refer to FIGS. 9 and 10. FIG. 9 is a perspective view of a reinforcement assembly 600 of the optical element driving mechanism 1, according to certain aspects of the present disclosure. FIG. 10 is a perspective view of the reinforcement assembly 600 and the driving assembly 300 of the optical element driving mechanism 1, according to certain aspects of the present disclosure.

The reinforcement assembly 600 is at least partially fixedly disposed on the first movable element 110. The reinforcement assembly 600 includes a first reinforcement element 610, a second reinforcement element 620, a third reinforcement element 630, a fourth reinforcement element 640, and a fifth reinforcement element 650. When viewed along the direction of the optical axis O1, the first reinforcement element 610 and the second reinforcement element 620 at least partially overlap, the first reinforcement element 610 and the third reinforcement element 630 do not overlap, and the second reinforcement element 620 and the third reinforcement element 630 at least partially overlap. When viewed along the normal direction of the surface of the first side 221 of the base 220 (i.e., the direction perpendicular to the optical axis O1), the third reinforcement element 630 located on the opposite side to the first side 221 at least partially overlaps with the first reinforcement element 610 located on the opposite side to the first side 221, and the third reinforcement element 630 located on the opposite side to the first side 221 does not overlap with the second reinforcement element 620 located on the opposite side to the first side 221.

The first reinforcement element 610 is disposed on the first movable element 110 and may be a magnetically conductive sheet made of a metallic material. The second reinforcement elements 620 are respectively disposed on the first magnetic element 312 and the third magnetic element 332, have an L-shaped configuration, and are made of a metallic material. The second reinforcement elements 620 correspond to the driving assembly 300. The attractive force between the first magnetic element 312 and the third magnetic element 332 and the second reinforcement elements 620 exerts opposite directional forces on the first magnetic element 312 and the third magnetic element 322, such that the internal structure of the optical element driving mechanism 1 is not overturned due to excessive magnetic force from the first magnetic element 312 and the third magnetic element 332.

The first reinforcement element 610 is movable relative to the second reinforcement element 620. The second reinforcement element 620 is at least partially located between the first reinforcement element 610 and the first magnetic element 312 of the driving assembly 300. The third reinforcement element 630 is made of a metallic material but is not magnetically conductive. The third reinforcement element 630 is connected to the first reinforcement element 610. A recessed structure of the third reinforcement element 630 corresponds to the first reinforcement element 610 and the third magnetic element 322. In this embodiment, the magnetic permeability of the first reinforcement element 610 is greater than that of the third reinforcement element 630. In some embodiments, the first reinforcement element 610 and the second reinforcement element 620 may have different magnetic permeabilities. In other embodiments, the first reinforcement element 610 and the second reinforcement element 620 may have the same magnetic permeability.

Next, please also refer to FIGS. 3A and 3B. The fifth reinforcement element 650 is disposed between the second magnetic element 322 and the fourth movable element 140. The fourth reinforcement element 640 is disposed between the second coil 324 and the housing 210, in order to prevent magnetic field interference. The reinforcement assembly 600 stabilizes the internal structure of the optical element driving mechanism 1 and reduces operational errors of the driving assembly 300 during operation.

The sensing assembly 700 includes a first sensing element 710, a second sensing element 720, and a third sensing element 730. The first sensing element 710, second sensing element 720, and third sensing element 730 are all disposed on the second circuit element 520. The first sensing element 710 is disposed between the first coils 314 to detect movement of the second movable element 120. The second sensing element 720 is disposed between the third coils 334 to detect movement of the fourth movable element 140. The third sensing element 730 is disposed within the second coil 324 to detect movement of the third movable element 130.

In the optical element driving mechanism 1, the optical axis O1 sequentially passes through the optical element 10, the housing opening 212, the first circuit element opening 515, the frame opening 232, the fifth movable element opening 152, the first movable element opening 117, the third movable element opening 137, and the bottom opening 223, thereby passing through the entire optical element driving mechanism 1.

Next, please refer to FIGS. 11 and 12. FIG. 11 is a perspective view of the optical element driving mechanism 1, according to certain aspects of the present disclosure, with the fixed portion 200 removed and the first movable element 110 shown in dashed lines for illustrative purposes.

FIG. 12 is a perspective view of the optical element driving mechanism 1, according to certain aspects of the present disclosure, with the fixed portion 200 and the first movable element 110 removed, and the second movable element 120 and the fourth movable element 140 shown in dashed lines for illustrative purposes.

The first guiding portion 410 movably connects the second movable element 120, the fourth movable element 140, and the first movable element 110. The second movable element 120 and the fourth movable element 140 drive the movement of the first movable element 110 via the first guiding portion 410.

The second guiding portion 420 movably connects the second movable element 120, the fourth movable element 140, the first movable element 110, the third movable element 130, and the bottom 220 of the fixed portion 200. The third movable element 130 is driven to move in the second dimension D2 via the second guiding portion 420.

The third guiding portion 430 movably connects the second movable element 120, the fourth movable element 140, and the third movable element 130. The second movable element 120 is movable along the first dimension D1 via the third guiding portion 430. The fourth movable element 140 is movable along the third dimension D3 via the third guiding portion 430.

In the present embodiment, the first guiding portion 410 is in the form of rolling balls. The first guiding grooves 111, 112, and 113 and the second guiding grooves 121, 122, and 123 have elongated structures extending along the third dimension D3, such that when the rolling balls of the first guiding portion 410 are positioned within the first guiding grooves 111, 112, 113 and the second guiding grooves 121, 122, 123, they may move along the third dimension D3. Since the rolling balls of the first guiding portion 410 have almost no space to move in the first dimension D1, when the second movable element 120 moves along the first dimension D1, the first movable element 110 is driven to move by the first guiding grooves 111, 112, and 113. Conversely, since the rolling balls of the first guiding portion 410 may move along the third dimension D3, when the first movable element 110 moves along the third dimension D3, the second movable element 120 is not driven by the movement of the first movable element 110.

The second guiding grooves 124, 125, and 126 and the third guiding grooves 131, 132, and 133 have elongated structures extending along the first dimension D1, such that when the rolling balls of the third guiding portion 430 are positioned within the second guiding grooves 124, 125, 126 and the third guiding grooves 131, 132, 133, they may move along the first dimension D1. Therefore, when the second movable element 120 is driven by the first magnetic element 312 and the first coil 314, it may move along the first dimension D1 relative to the third movable element 130.

The first guiding grooves 114, 115, and 116 and the fourth guiding grooves 141, 142, and 143 have elongated structures extending along the first dimension D1, such that when the rolling balls of the first guiding portion 410 are positioned within the first guiding grooves 114, 115, 116, they may move along the first dimension D1. Since the rolling balls of the first guiding portion 410 have almost no space to move along the third dimension D3, when the fourth movable element 140 moves along the third dimension D3, the first movable element 110 is driven to move via the third guiding portion 430. Conversely, since the rolling balls of the first guiding portion 410 may move along the first dimension D1, when the first movable element 110 moves along the first dimension D1, the fourth movable element 140 is not driven by the movement of the first movable element 110.

The fourth guiding grooves 144, 145, and 146 and the third guiding grooves 134, 135, and 136 have elongated structures extending along the third dimension D3, such that when the rolling balls of the third guiding portion 430 are positioned within the fourth guiding grooves 144, 145, 146 and the third guiding grooves 134, 135, 136, they may move along the third dimension D3. Therefore, when the fourth movable element 140 is driven by the third magnetic element 332 and the third coil 334, it may move along the third dimension D3 relative to the third movable element 130.

The second guiding portion 420 consists of two guide rods. When the third movable element 130 is driven by the second magnetic element 322 and the second coil 324, it may move along the second dimension D2 relative to the bottom 220 of the fixed portion 200 via the two second guiding portions 420.

When the second movable element 120 moves along the first dimension D1, it drives the movement of the first movable element 110.

When the first movable element 110 moves along the third dimension D3, it almost does not drive the second movable element 120 to move.

In another embodiment, the first guiding portion 410 and the third guiding portion 430 may be in the form of spring pieces (not shown). In such a configuration, the first guiding portion 410 and the third guiding portion 430 are separate spring elements that individually connect the first movable element 110, the second movable element 120, the third movable element 130, and the fourth movable element 140.

In summary, the present invention provides an optical element driving mechanism that includes a plurality of movable elements, a fixed portion, a driving assembly, a circuit assembly, a guiding assembly, and a sensing assembly. The movement of the driving assembly drives multiple movable elements to move relative to one another and to the fixed portion. Thus, the position of the optical element may be adjusted to accommodate different imaging requirements and to provide more stable optical quality. Furthermore, since the first circuit element of the circuit assembly is flexible and may be connected to the movable portion, the present invention does not require complex circuit routing or corresponding structures on the movable portion for electrical connection with the fixed portion, thereby achieving reduced cost, simplified overall structure, and simplified circuit design.

Although one or more embodiments of the invention have been illustrated and described herein, it will be understood by those skilled in the art, upon reading and understanding this specification and the accompanying drawings, that equivalents and modifications will readily come to mind. Additionally, although specific features of the invention may have been disclosed in the context of only one embodiment, such features may be combined with one or more other features of other embodiments as needed and beneficial for any given application.

Although various embodiments of the present invention have been described above, it should be understood that these are presented by way of example only and not limitation. Various changes may be made to the described embodiments without departing from the spirit or scope of the invention. Therefore, the scope of the invention should not be limited by the above embodiments, but rather should be defined by the following claims and their equivalents.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Furthermore, the terms “including,” “has,” “having,” “with,” and any variations thereof as used in the specification and/or claims are intended to be inclusive in a manner similar to the term “comprising.”

What is claimed is:

1. An optical element driving mechanism, comprising:
a movable portion, configured to connect to an optical element;
a fixed portion, wherein the movable portion is movable relative to the fixed portion; and
a driving assembly, configured to drive the movement of the movable portion.

2. The optical element driving mechanism as claimed in claim 1, further comprising a circuit assembly, configured to connect to an external circuit, wherein the circuit assembly includes a first circuit element, the first circuit element comprising:
a fixed end, at least partially fixedly connected to the fixed portion;
a movable end, at least partially fixedly connected to the movable portion;
a plate-shaped main body; and
a flexible portion, wherein the movable end is movably connected to the fixed end via the flexible portion and the plate-shaped main body.

3. The optical element driving mechanism as claimed in claim 2, wherein the movable end comprises:
a first connection portion;
a second connection portion; and
a third connection portion, wherein the second connection portion is located between the first connection portion and the third connection portion, and wherein:
the first connection portion, the second connection portion, and the third connection portion are configured to electrically connect to an optical element module; and
the first connection portion, the second connection portion, and the third connection portion are electrically connected to the fixed end via the flexible portion.

4. The optical element driving mechanism as claimed in claim 3, wherein the fixed portion includes:
a housing, wherein an optical axis passes through the housing;
a bottom, having a first side and a second side, wherein the first side is adjacent to the second side; and
a frame, wherein:
the bottom and the housing form a first receiving space, for accommodating the movable portion and the circuit assembly; and
the frame and the housing form a second receiving space, for accommodating the first circuit element.

5. The optical element driving mechanism as claimed in claim 4, wherein:
the movable portion and the first circuit element are respectively located on opposite sides of the frame; and
when viewed along the optical axis, the movable portion and the first circuit element at least partially overlap.

6. The optical element driving mechanism as claimed in claim 4, wherein:
When viewed along the optical axis, the first connection portion, the second connection portion, and the third connection portion are arranged in a straight line parallel to the first side of the bottom; and
the flexible portion extends around the optical axis by at least 180 degrees.

7. The optical element driving mechanism according to claim 4, wherein when the movable portion is in an extreme position, the flexible portion does not fully contact the frame.

8. The optical element driving mechanism as claimed in claim 4, wherein the circuit assembly further includes a second circuit element, having an external connection terminal, wherein:
the external connection terminal is at least partially fixedly connected to the fixed portion;
the external connection terminal and the fixed end are disposed between the second side and the housing; and
the external connection terminal and the fixed end each have a plurality of connection portions arranged parallel to the second side.

9. The optical element driving mechanism as claimed in claim 1, further comprising a reinforcement assembly, at least partially fixedly disposed on the movable portion, wherein the reinforcement assembly includes:
a first reinforcement element, having a metallic material; and
a second reinforcement element, having a metallic material, wherein the second reinforcement element corresponds to the driving assembly; and
wherein:
the first reinforcement element is movable relative to the second reinforcement element; and
the second reinforcement element is at least partially located between the first reinforcement element and the driving assembly.

10. The optical element driving mechanism as claimed in claim 9, wherein the reinforcement assembly further comprises:
a third reinforcement element, having a metallic material, the third reinforcement element is connected to the first reinforcement element;
the magnetic permeability of the first reinforcement element is greater than the magnetic permeability of the third reinforcement element; and
the third reinforcement element includes a recessed structure, corresponding to the first reinforcement element and the driving assembly.

11. The optical element driving mechanism as claimed in claim 1, wherein the movable portion includes:
a first movable element; and
a second movable element, movable relative to the fixed portion in a first dimension, wherein when the second movable element moves, the second movable element drives the first movable element to move.

12. The optical element driving mechanism as claimed in claim 11, further comprising a third movable element, movable relative to the fixed portion in a second dimension, wherein when the third movable element moves, the third movable element drives the first movable element and the second movable element to move.

13. The optical element driving mechanism as claimed in claim 12, wherein:
the first movable element is movable relative to the third movable element; and
the third movable element is movable relative to the second movable element.

14. The optical element driving mechanism as claimed in claim 12, further comprising a fourth movable element, movable relative to the fixed portion in a third dimension, wherein:
when the fourth movable element moves, the fourth movable element drives the first movable element to move;
when the fourth movable element moves, the fourth movable element does not drive the second movable element to move; and
when the third movable element moves, the second movable element does not drive the fourth movable element to move.

15. The optical element driving mechanism as claimed in claim 14, wherein the fourth movable element is movable relative to the first movable element and the second movable element.

16. The optical element driving mechanism as claimed in claim 14, wherein the driving assembly includes:
a first magnetic element, at least partially fixedly disposed on the second movable element;
a first coil, corresponding to the first magnetic element, wherein the second movable element is movable relative to the first coil;
a second magnetic element, at least partially fixedly disposed on the third movable element;
a second coil, corresponding to the second magnetic element, wherein the third movable element and the second movable element are movable relative to the second coil; and
a third magnetic element, at least partially fixedly disposed on the fourth movable element, wherein the third magnetic element is movable relative to the first magnetic element and the first coil.

17. The optical element driving mechanism as claimed in claim 14, further comprising a guiding assembly, wherein the guiding assembly includes a first guiding portion, configured to guide the relative movement between the first movable element and the second movable element and the fourth movable element.

18. The optical element driving mechanism as claimed in claim 17, wherein the guiding assembly further includes a second guiding portion, configured to guide the relative movement between the third movable element and the second movable element and the fourth movable element in a second dimension.

19. The optical element driving mechanism as claimed in claim 18, wherein:
the first movable element includes a plurality of first guiding grooves;
the second movable element includes a plurality of second guiding grooves;
the third movable element includes a plurality of third guiding grooves; and
the fourth movable element includes a plurality of fourth guiding grooves;
wherein:
the first guiding portion is in the form of rolling balls, disposed within the plurality of first guiding grooves, the plurality of second guiding grooves, and the plurality of fourth guiding grooves; and
the first guiding portion is movable in the first dimension and the third dimension.

20. The optical element driving mechanism as claimed in claim 18, wherein the guiding assembly further includes a third guiding portion, configured to guide the relative movement between the third movable element and the second movable element and the fourth movable element, wherein:
the third guiding portion is in the form of rolling balls, disposed within the plurality of third guiding grooves, the plurality of second guiding grooves, and the plurality of fourth guiding grooves; and
the third guiding portion is movable in the first dimension and the third dimension.
